(19) United States
(12) Patent Application Publication
(10) Pub. No.: US 2003/0232183 A1
(43) Pub. Date: Dec. 18, 2003

(54) Process for making a foam component

(75) Inventor: Daniel James Dufton, Newcastle-Upon-Tyne (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/386,288

(22) Filed: Mar. 11, 2003

Related U.S. Application Data
(63) Continuation of application No. PCT/IB01/01626, filed on Sep. 7, 2001.

(30) Foreign Application Priority Data
Sep. 13, 2000 (GB) 0022496.4

(51) Int. Cl. B31B 1/60

(52) U.S. Cl. 428/304.4; 264/45.1; 156/60

(57) ABSTRACT

Process for making a foam component by obtaining a first and a second wet foam shape, then drying, partially or completely, the first foam shape and second foam shape and then superposing the dry or partially dry first and second foam shapes and attaching the first and second foam shapes to one another. The invention also provides foam components obtained by such a process.

### CROSS REFERENCE TO RELATED APPLICATIONS

This application is a continuation application of International Application PCT/IB01/01626 with an international filing date of Sep. 7, 2001, published in English under PCT Article 21(2) which claims priority to Great Britain Application No. 0022496.4, filed Sep. 13, 2000.

### TECHNICAL FIELD

The present invention relates to a process for making a water-reactive foam components by forming a first and a second wet foam shape, drying or partially drying these foam shapes and then attaching the foam shapes to another, to obtain the foam component. The invention also relates to components obtainable by such a process.

### BACKGROUND TO THE INVENTION

Recently, there has been a trend to make various cleaning compositions but also personal cleansing and care compositions in unit dose form. For example detergent tablets are being used widely. It has also been described that foams can be used hold active ingredients.

The inventor has found an improved method of making foam objects, typically of water-soluble foams, formed from water-reactive polymers and active materials (active in water). It was found that a preferred method for making foam components is to make a solution or dispersion from the polymeric material and the active material, and forming thereof a wet foam, typically by introducing a gas, which is then subsequently dried. However, the inventor found that drying these foam components is often very lengthy and often not done satisfactorily, for example, because the foam is not dried homogeneously, the drying conditions have impacted the actives negatively, or it is not possible to dry the foam component completely.

The inventor now found an improved process to make water-reactive foam components from a solution or suspension, by forming separate foam shapes first and drying or partially drying these foam shapes and then forming a foam component from these foam shapes, typically by making firstly separate foam sheets and then superposing and attaching the sheets, to obtain thus a layered foam component or object.

The overall drying time is significantly reduced by use of the process of the invention. Also, the drying conditions are more compatible with the active material, in particular when these include volatile or heat sensitive actives.

This process can be used to make a range and shapes of foam component and types of foam components, for example comprising cleaning products, pharmaceutical products, personal-care products, cosmetic products and fabric-care products.

The resulting foam component has a very good quality, in particular it is very stable and flexible or elastic, and delivers the actives effectively to water. It has also been found to be very impact resistant. An additional benefit can be that different active materials can thus be incorporated in different foam shapes, and thus in one foam component, without being directly in contact with another, or having only limited contact.

### SUMMARY OF THE INVENTION

The present invention relates to a process for making a foam component by:

a) obtaining a first wet foam shape and a second wet foam shape, each comprising a polymeric material, an active material and a liquid;

b) evaporating part or all of the liquid of the first and/or second foam shape to obtain dry or partially dry foam shape(s);

c) placing the first foam shape and the second foam shapes of step b) against one another and attaching the shapes to one another.

The foam component is preferably water-soluble and/or water-dispersible. The foam component is typically air-stable. The dry foam shape(s) comprise typically a polymer matrix and an active material, which is active in water.

The liquid or part thereof can be evaporated by any method, for example heating or freeze-drying. Preferred may be that the wet foam shape is made under pressure and that by releasing the pressure, the liquid or part thereof evaporates, optionally followed by another drying step.

The foam shapes are preferably made from a liquid (viscous) mixture of a polymeric material and an active material and a liquid and then introducing a gas (or an agent which forms a gas at 25° C. and atmospheric pressure); and then shaping the mixture and drying the wet foam shapes. Again, preferably the viscous mixture is processed and foamed under pressure and when shaping the mixture, the pressure is released, to evaporate part of the liquid.

The invention also relates to foam components obtainable by the process of the invention, having at least two foam shapes attached to another, preferably in the form of layers of foam shapes or sheets, to give the foam component a layered structure.

The foam component obtainable by the process herein releases the active material or part thereof upon contact with water, the component preferably partially or completely disintegrating, dispersing, denaturing and/or dissolving upon contact with water. This foam component is preferable a flexible foam component.

Preferably the active materials are cleaning actives, personal care or cosmetic actives or pharmaceutical actives. Preferred are temperature-sensitive or volatile actives or moisture sensitive actives, including enzymes, bleach, perfumes.

The foam component may preferably be in the form of an article comprising a unit dose amount of product (active material), having two or more layers formed from the foam shapes, preferably being a geometric object, including a sheet, cube, sphere or other shape allowing easy handling of a unit dose of the composition.

### DETAILED DESCRIPTION

The process of the invention involves obtaining at least two wet foam shapes (a first, a seconds and optionally further wet foam shapes), evaporating liquid from the wet foam shapes to obtain partially or completely dry foam shapes, and placing one foam shape against another foam shape and attaching the foam shapes to one another.

Wet foam shape as used herein means a foam shape comprising a liquid (liquid at 25° C. and atmospheric pressure) capable to be evaporated, typically under known drying conditions including air drying, heating, vacuum drying, (vacuum) freeze drying.

When the foam shapes are formed from a liquid, polymeric material and active material, the liquid is preferably a solvent capable of dissolving the polymer and/or active material or part thereof, typically at least an organic solvent or water, preferably at least water. Typically the polymeric material is water-soluble and the liquid comprises at least water. It may be preferred that the liquid is a mixture of materials, for example a mixture of water and an organic solvent, capable of lowering the boiling point of water. The amount of liquid used is preferably kept as low as possible, to reduce the need of drying of the foam shape and foam component. The polymeric material and active material are preferably homogeneously dissolved or suspended within the solvent and the amount of liquid is thus selected accordingly.

The amount of liquid, or preferably solvent, in the wet foam shape is typically from 15% to 50% by weight of the mixture, more preferably from 15% to 45% or even 40% by weight, or even from 20% to 40% or even 35% by weight.

The level of liquid in the resulting foam component is preferably up to 15% by weight, more preferably up to 12% or even up toIO% or even up to 5% by weight. It may be preferred that at least some liquid remains present for example at least 1% or even at least 3% by weight.

The wet foam shapes can be made by any known process for making foams from a foaming polymeric material and a liquid. Typically, the foam shape is made from a solution or suspension, preferably a viscous suspension or solution of a polymeric material an active material and a liquid, and preferably a plasticizer. This is then typically foamed by introduction of a gas, as described herein in more detail.

The thus obtained mixture can than be shaped in the required wet foam shape to allow evaporation of the liquid or part thereof.

Typically the evaporation of the foam shapes is done by known methods such as air drying, heating, vacuum drying, (vacuum) freeze drying, or mixtures thereof. Also preferred is a method whereby the foam is made under pressure and the release of pressure evaporates the liquid or part thereof.

It may be preferred that the foam shapes are such that only limited drying is necessary prior to attaching the shapes. For example the foam shapes may preferably be obtained by a method whereby only limited amounts of liquid are used, as described below in more detail. The drying step is typically to be done such that the final foam component is of about the same volume after the drying step as before the drying step. Thereto, the drying step is preferably done by freeze-drying, whereby the solvent, e.g. water, is removed under vacuum and reduced temperatures, for a short period of time and also useful can be slow oven drying at modestly increased temperatures, such as 40-70° C., or even 40-60° C. for a short period of time, for example up to a maximum of 2 hours or even up to 1 hour.

The two or more foam shapes are placed against one another, to allow attachment. This means that at least part of the surface of one foam shape is contacted with at least part of the surface of another foam shape. Preferably, may be that at least 50% of the largest surface of one shape is contacted with at least 50% of the largest surface of another foam shape. The exact manner of placing the foam shapes depends on the shape requirements of the final foam component. Preferred may be that the two or more foam shapes are in the from of sheets and that these are placed against one another (superposed on one another) and thus form a layered foam component, which then optionally can be further shaped. Sheets are preferred shapes, because they have a high surface: volume-ratio and they dry quicker or easier.

The foam shapes are attached to another my any method. If the foam shapes are still partially wet, this may be sufficient to allow fixation of the shapes to another; this may then typically be followed by further drying to obtain the foam component of the invention. It may also be preferred that the surface of one or all (dry) foam shape(s) to be attached to one another is re-wetted by applying a liquid to the surface(s). Preferably this is the same liquid as used to form the wet foam shape, preferably solvent as described herein. For example, a liquid can be used which is a solvent for the polymeric material in the foam matrix of the foam shape, e.g. water.

The foam shapes may also be attached by use of a glue. This can for example be a polymer solution or suspension; for example, the foam shapes can be glued together using a solution of the polymeric material used to make the foam shape or shapes. Of course, a solution of a different polymer may also be used.

Preferred may be that a more water-soluble material than the polymer used in the shape or shapes is used to glue the shapes together, because this allow disintegration of the foam components in to its individual shapes, for example the foam shapes separate first from one another, prior to dissolution of the individual shapes. Gluing with a non-soluble glue may also be useful for certain executions herein.

A mixture of gluing methods herein may also be used to attach two shapes. Also, a different method of gluing may be used for one connection than for another connection.

With all of the above gluing methods it is preferred to apply pressure to the shapes (e.g. compressing the foam shapes together).

As described herein, it can be useful that the foam shapes comprises at a plasticizer and/ or a stabilizer to improve foam formation and stabilization. Preferred is that at least a plasticizer is present in the mixture. Preferred are levels of from 3% to 25% by weight, more preferably from 5% to 20% by weight or even from 8% to 18% by weight (of the wet foam shape) of plasticizer and/or stabilizer.

The level of polymeric material in the wet foam shape is preferably from 10% to 60% by weight, more preferably from 15% to 50% by weight or even from 20% or even 25% to 45% by weight. The final foam component comprises preferably at least 10% by weight of the polymeric material, more preferably from 10% or even 20% or even 30% to 70%, or even to 60% or even to 55% or even to 50% by weight.

The level of active material in the wet foam shape is preferably from 10% to 60% by weight, more preferably from 15% to 50% by weight or even from 20% to 45% by weight of the mixture. The final foam component comprises preferably at least 10% by weight of the active ingredients, more preferably from 10% to 70% or even from 15% to 60% by weight.

Preferred Process for Making Foam Shape(s)

The foam shape(s) herein is preferably obtainable by a process comprising the step of

a) formation of a mixture of the polymeric material an active ingredient and a liquid, preferably including water;

b) evaporation of the liquid or part thereof to form spacings which are the areas inside cells of the matrix of the foam shape.

Preferably, the foam shape(s) are obtainable by a process involving:

a) obtaining a (viscous) liquid mixture of a polymeric material and an active material and a liquid;

b) introducing in the mixture, a gas (or agent which forms a gas at 25° C and atmospheric pressure);

c) shaping the mixture of step b) to form a foam shape.

In these processes, the mixture may be mildly heated, up to for example temperatures from 40° C. to 70° C., preferably only up to 60° C. or even 55° C., to improve the shaping and to cause the liquid or part thereof to evaporate more efficiently. Typically, the temperature of the mixture is below the melting point of the polymeric material and preferably up to a temperature below the boiling point of the liquid at atmospheric pressure.

Preferred is also that one or each of steps a) to c) is done under pressurizing. The pressure used in the process is preferably at least 5 bar or at least 10 bar or even at least 15 bar. Preferably, the pressure used is up to 300 bar or even up to 250 bar or even up to 100 bar or even up to 50 bar.

Preferred is that the mixture of step a) above is intensively mixed and/or has a specific viscosity.

Preferred hereby is that the mixture of the polymeric material, active material and liquid, either has a viscosity of at least 150 Pa.s at a sheer rate of 1.7 s⁻¹ or is intensively mixed, thereby obtaining the required viscosity to be processed, namely such that it is viscous enough to be pressurized, and shapes, but preferably not too viscous to introduce the gas or agent and/or be shaped.

The mixture preferably has a viscosity (at 25° C.) of at least 200Pa.s or even at least 250 Pa.s or even at least 300 Pa.s or even at least 350 Pa.s, measured at a shear rate of 1.7 s⁻¹.

Preferably, the viscosity is such that measured (at 25° C.) at a shear rate of 10.0 s⁻¹, the viscosity is at least 100 Pa.s or even at least 150 Pa.s or even at least 200 Pa.s or even at least 250 Pa.s. More preferably, the viscosity is also such that measured (at 25° C.) at a sheer rate of 100.0 s^{-1,} the viscosity is at least 12 Pa.s or even at least 16 Pa.s or even at least 20 Pa.s or even at least 28 Pa.s.

Preferably the mixture has the viscosity as specified herein and is then also intensively mixed, as specified herein, in particular because the intensive mixing helps obtaining the required viscosity.

Viscosity regulators may also be useful, for example additional thickening agents or hydrotropes may be used.

Intensive mixing when used herein means mixed with a power/mass of at least 20 W/gr, preferably at least at least 30 W/gr or even at least 50 W/gr or even at least 100 W/gr or even at least 200 W/gr or even at least 250 W/gr, preferably up to 1000 W/gr or even up to 500 W/gr.

Preferred mixers used for this intensive mixing process are also capable of applying the required pressure; preferred are known extruders.

A preferred process herein is an extrusion process. Hereby it is preferred that the polymeric material, active ingredient, gas or agent described herein and typically liquid, preferably including a solvent such as water, are introduced into an extruder (as a pre-formed mixture, or preferably as separate ingredients), wherein the ingredients are mixed; then, the pressure is dropped at the exit point where the extruded mixture exits the extruder and is thereby shaped, whereby the liquid or part thereof evaporates (when leaving the exit point, it can be formed into the desired shape, for example a sheets, or this may be done at a later stage, for example after a further treatment step such as drying). This results in formation of cells with spacings, as described herein after in more detail, which then may contain a gas, preferably air, and optionally the active ingredient. These spacings form the internal area of the cells of the matrix of the foam shapes. The formation of these spacings are partially responsible for the excellent flexibility of the foam components obtainable by the process of the invention.

In the process for making the foam shapes, the foaming is typically done by introduction of a gas, or an agent which forms or is a gas at atmospheric pressure and 25° C. This is typically done by introducing said gas or agent in the mixture of liquid, polymeric material and active material, as for example set out herein.

This may be gas introduced by (intensively) mixing. Preferred is however, that an additional source of gas is introduced to aid foaming, by further physical foaming and/or chemical foaming. This can be done by any known method, preferred are

physical foaming by gas injection (dry or aqueous route), gas dissolution and relaxation including critical gas diffusion (dry or aqueous route);

chemical foaming by in-situ gas formation (via chemical reaction of one or more ingredients, including formation of carbon dioxide by an effervescence system).

Also steam blowing and/or UV light radiation curing can be used.

(It should be understood that the viscosity of the viscous mixture as defined herein above, are then of the viscous mixture as determined prior to incorporation of the additional gas or agent.)

Preferred gasses injected into the mixture include nitrogen, carbon dioxide or mixtures thereof, such as also air.

The agents herein can for example be pressurized gasses, e.g. super critical fluids, such as liquid nitrogen or preferably carbon dioxide.

Preferred may be that the dry or partially dry foam shapes are obtained by first evaporation of part of the liquid by release of pressure, as described above and subsequently remaining liquid is evaporated by heating the foam shape(s) by methods as set out above.

Foam Component

The foam component obtainable by the process of the invention typically have a matrix formed from the polymeric material or part thereof, and optionally other materials. The matrix is preferably such that it forms an interconnected network of open and/or closed cells, in particular a network of solid struts or plates which form the edges and faces of open and/or closed cells. The spacing inside the cells can contain part of the active ingredient and/or a gas, such as air.

It is preferred that the foam component is formed from at least 3 or even at least 4 or even at least 5 foam shapes.

The foam component can contain any active ingredient, which is active in water. It may be preferred that the foam shapes in the component are not equal, and that they thus have other physical or chemical properties. Preferred may be that one foam shape comprises other active ingredients then another foam shape, for example active materials which are not compatible with one another and are thus separated from one another by incorporating them in different foam shapes. It may also be such that the foam shapes have different properties, allowing sequential release of the actives from different shapes. For example, different shapes can be made of different levels or types of polymer material (s), comprise different liquids or different plasticizers.

‘Air-stable’ or ‘stable upon contact with air’ when used herein, means that the bulk volume of the foam component substantially remains the same when exposed to air. This means in particular that the foam component herein retains preferably from 75% to 125% or even from 90% to 1 10% or even from 95% to 100% of its bulk volume when stored in an open beaker (9 cm diameter; without any protective barrier) in a incubator under controlled ambient conditions (humidity=RH 60%, temperature=25° C.) for 24 hours. Preferably the foam component retains from 75% to 125% or even from 90% to 110% or even from 95% to 100% of its bulk volume under the above storage conditions whereby the humidity is 80%.

The bulk volume change can be measured by any conventional method. In particular useful is a digital image recorder system containing a digital camera coupled to a personal computer itself equipped with a calibrated image analyzer software. A 1 cm³ specimen of the foam component is obtained and introduced in an open beaker having a diameter of 9 cm and stored for 24 hours at the above conditions. After 24 hours, the size in all three dimensions is measured with the image analysis recorder system. Each specimen measurement is repeated three times, and the average bulk volume change is calculated in %.

Preferably, the foam component is such that, when in the formed into particles of a mean particle size of 2000 microns or less, these foam component particles also retain from 75% to 125% or even from 90% to 110% or even from 95% to 100% of their bulk volume. This can for example be measured by placing 20 grams of the foam component particles, or a weight comprising more than 500 particles, in a volumetric beaker having a diameter of 9 cm. The beaker is taped lightly on its base until the foam component particles re-arrange themselves in a stable position with a horizontal top surface. The volume is measured. The open beaker with the foam component particles is then carefully placed in the incubator for 24 hours, set to the desired % RH and temperature. The bulk volume after the 24 hours is measured and the change of bulk volume is calculated in %.

The foam component herein is unstable when brought into contact with water. This occurs such that the active ingredients or part thereof, present in the foam component is delivered to the water. Preferably the foam component or part thereof denatures, disintegrates, preferably disperses or dissolves in water. It may be preferred that the polymeric material of the foam component disperses or dissolves rapidly, preferably at least 10% of the polymeric material, by weight, is dissolved or dispersed in 30 minutes after contacting the foam component with the water, more preferably at least 30% or even at least 50% or even at least 70% or even at least 90% (introduced in the water at a 1% by weight concentration). It may even be preferred that this happens within 20 minutes or even 10 minutes or even 5 minutes after contacting the foam component with the water. The dissolution or dispersion can be measured by the method described herein after for measuring the dissolution and dispersion of polymers.

Preferably the water-unstable foam component is such that the total volume of the foam component is changed, preferably reduced, with at least 10%, compared to the initial total volume, as for example can be determined when 1 cm³ of a foam component is added to 100 ml of demineralized water upon and stirred for 5 minutes at a speed of 200 rpm, at a temperature of 25° C. Preferably the change, or preferably reduction, in total volume is at least 20% or even at least 40% or even at least 60% or even at least 90% or even about 100%, e.g. because it may be preferred that substantially the whole foam component is disintegrated, dispersed or dissolved into the water quickly.

This can be measured by use of any method known in the art, in particular herein with a method as follows (double immersion technique):

1 cm³ of a foam component is obtained and introduced in a 100 ml micro volumetric measuring cylinder which is filled with 50 ml±0.1 ml of an organic inert solvent. Acetone is for example used when found to be neither denaturing and/or not interacting with the polymeric material in the foam component, for example when this is PVA. Other neutral organic medium can be used according to the nature of the foam under investigation; the inert solvent is such that the foam component is substantially not dissolved, dispersed, disintegrated or denatured by the solvent.

The cylinder is air sealed and left to rest for 1 minute so that the solvent penetrates the whole foam specimen. The change in volume is measured and taken as the original volume Vᵢ of the foam specimen. The foam specimen is then removed from the solvent and left to dry in air so that the solvent evaporates.

The foam specimen is then placed in a 250 ml beaker containing 100 ml of demineralized water, maintained at 25° C., under stirring at 200 rpm with the help of a magnetic stirrer, for 5 minutes. The remaining of the foam component specimen is filtered off with a 60 mm mesh copper filter and placed in a oven at a temperature and for a period such that residual water is removed. The dried remaining foam component is re-introduced in the measuring cylinder which volume of acetone had been re-adjusted to 50 ml.

The increase in total volume is monitored and taken as the final volume of the foam specimen V_{f}. The decrease in total volume ΔV of the foam specimen is then:

$$\% Δ V = \frac{Vf}{Vi} * 100$$

The foam component has preferably a relative density φ*_{foam} of from 0.01 to 0.95, more preferably from 0.05 to 0.9 or even from 0.1 to 0.8 or even form 0.3 to 0.7. The relative density is the ratio of the density of the foam component to the sum of the partial densities of all the bulk materials used to form the foam component, as described below:

$${ρ}_{foam}^{*} = \frac{{ρ}_{foam}}{{ρ}_{bulk}} = \frac{{ρ}_{foam}}{{\sum }_{i = 1}^{i = n} {χ}_{i} {ρ}_{i}}$$

where ρ is the density, and χᵢ is the volume fraction of the materials i in the foam components.

It is preferred that the foam component is a flexible foam component. In particular, this means that the flexible foam component reversibly deforms, absorbing the energy of impacts or of forces so that the foam component remains substantially its original bulk volume after the physical force seizes to be applied on the component.

In particular this means that when a foam component sample having a cross section of a specific length, for example 1 cm, is compressed with a static force applied along the axis of that cross section, the static force being variable but at least equivalent to twice atmospheric pressure, the change of this length after removal of the force is at least 90% to 110% of the original length. This can for example be measured by use of Perkin-Elmer DMA 7e equipment.

Similarly, the foam component is preferably flexible to such an extend that when a foam component sample having a cross section of a specific length, for example 1 cm, is stretched with a static force applied along the axis of that cross section, the static force being variable, but at least equivalent to twice atmospheric pressure, the change of this length after removal of the force is at least 90% to 110% of the original length. This can for example be measured by use of Perkin-Elmer DMA 7e equipment.

The flexibility of a foam component can also be reflected by the Young's or elastic modulus, which can be calculated from strain or stress mechanical tests as known in the art, for example by using Perkin-Elmer DMA 7e equipment following the manufacturer's experimental procedure. For example a foam component of 1 cm³ can be used in the testing with this equipment.

In particular, when using this equipment, the static forces applied along the axis of a cross section of a 1 cm³ foam component are gradually increased until the deformation of the component, in the direction of the cross section, is 70%. Then, the force is removed and the final deformation of the foam component in the direction of the cross section is measured. Preferably, this length of the cross section after this experiment is preferably from 90% to 110% of the original length of the cross section, preferably from 95% to 105% or even from 98% to 100%.

The foam component herein preferably has an elastic modulus or Young's modulus of less than 10 GN.m⁻², even more preferentially less than 1 GN.m⁻², as measured with the Perkin-Elmer DMA 7e equipment. Preferably the polymeric component has a relative yield strain greater than 2%, and preferably greater than 15% or even greater than 50%, as measured with the Perkin-Elmer DMA 7e equipment. (The yield strain is in this measurement the limit deformation of a foam component at which the component deforms irreversible).

The elastic modulus or Young modulus is related to the relative density, namely

$$\frac{{E}^{*}}{{E}_{s}} \approx {( \frac{{ρ}^{*}}{{ρ}_{s}} )}^{2} ,$$

where ρ* and ρₛ are as described above and E* is the Young's modulus of the foam component, and Eₛ that of the polymeric material. This means that even stiff polymeric materials, with a high Eₛ can be made into relatively flexible foams, by modifying the density thereof, in particular by introducing more gas in during the foam making process or by using additives, such as plasticizers at adjusted levels.

The foam component preferably also comprises additional ingredients to improve (the performance of) the foam, for example to strengthen the foam component or make the foam component more stable, or more flexible or more water-soluble or water-dispersible, or which provide a better appearance of the foam, for example to color or bleach the foam component.

Preferred are plasticizers, stabilizers, dissolution agents as described herein after. Some of the preferred stabilizers, dissolution aids and plasticizers can have dual functionality, for example both plasticsizing and stabilizing the foam component of the invention.

The foam component herein preferably comprises a stabilizing agent, which is typically capable of stabilizing the active ingredient of the foam component herein, this is especially preferred when the active ingredient(s) comprise an oxidative or moisture sensitive active ingredient, such as one or more enzymes, perfumes and/or bleaching agents. The stabilizing agent may also stabilize the matrix of the foam component herein, and thus indirectly stabilize the active ingredient.

The stabilizing agent is preferably a compound which stabilizes the active ingredient, or matrix, from oxidative and/or moisture degradation during storage.

The stabilizing agent may be, or comprise, a foam or a matrix stabilizer. The stabilizing agent may be, or comprise, an active ingredient stabilizer, especially an enzyme stabilizer.

Preferred foam stabilizers comprises one or more anions or cations such as mono-, di-, tri-valent, or other multivalent ions, preferred are ions of the following metals: sodium, calcium, magnesium, potassium, aluminum, zinc, copper, nickel, cobalt, iron, manganese and silver; preferably these cations have a counter ions one or more of the following anions: sulphate, carbonate, oxide, chloride, bromide, iodide, phosphate, and nitrate, and combinations thereof.

The foam stabilizer may comprise finely divided particles, preferably finely divided particles having an average particle size of less than 10 micrometers, more preferably less than 1 micrometer, even more preferably less than 0.5 micrometers, or less than 0.1 micrometers. Preferred finely divided particles are aluminosilicates such as zeolite, silica, or electrolytes described hereinbefore being in the form of finely divided particles.

The foam stabilizer may comprise agar-agar, sodium alginate, sodium dodecyl sulfate, polyethylene oxide, guar gum, polyacrylate, or derivatives thereof, or combinations thereof.

The foam stabilizer may comprise anionic or nonionic proteins or phospholipid-protein complexes.

The foam component as a whole, or the active material prior to introduction into the foam component, may also be coated with a layer of a (polymeric) material, not being in the form of a foam as defined herein. Preferred coating agents include PVP (and derivatives thereof) and/ or PEG (and derivatives thereof) and PVA (and derivatives thereof) or mixtures of PVA with PEG and/or PVP (or derivatives thereof); glycerol or glycerin, glycol derivatives including ethylene glycol, digomeric polyethylene glycols such as diethylene glycol, triethylene glycol and tetraethylene glycol, polyethylene glycol with a mean average Molecular weight of below 1000 daltons, wax and Carbowax, ethanolacetamide, ethanolformamide, triethanolamine or acetate thereof, and ethanolamine salts, sodium thiocyanates, ammonium thiocyanates, polyols such as 1,3-butanediol, sugars, sugar alcohols, ureas, dibutyl or dimethyl pthalate, oxa monoacids, oxa diacids, diglycolic acids and other linear carboxylic acids with at least one ether group distributed along the chain thereof, water or mixtures thereof.

Preferred active stabilizers comprise boric acid and salts thereof, and formic acid and formate salts and acetic acid and acetate salts, preferably calcium and/or magnesium salts thereof.

Active stabilizers suitable for use herein, especially when the foam component herein comprises a bleach, comprise anti-oxidants and/or reducing agents such as thiosulphate, methionine, urea, thiourea dioxide, guanidine hydrochloride, guanidine carbonate, guanidine sulfamate, monoethanolamine, diethanolamine, triethanolamine, sodium glutamate, bovine serum albumin and casein, tert-butylhydroxytoluene, 4-4,-butylidenebis (6-tert-butyl-3-methyl-phenol), 2,2′-butlidenebis (6-tert-butyl-4-methylphenol), (monostyrenated cresol, distyrenated cresol, monostyrenated phenol, distyrenated phenol, 1,1-bis (4-hydroxy-phenyl) cyclohexane, or derivatives thereof, or a combination thereof.

Active stabilizers suitable for use herein may comprise sugars. Typical sugars for use herein include those selected from the group consisting of sucrose, glucose, fructose, raffinose, trehalose, lactose, maltose, derivatives thereof, and combinations thereof.

It may be preferred that the active stabilizer is in the form of a coating or barrier which at least partially encloses the foam component herein or the active ingredient thereof, preferably completely encloses the foam component herein or the active ingredient thereof, especially an enzyme.

The foam component herein may comprise (by weight) from 1%, or from 2%, or from 5%, or from 7%, or from 10%, or from 15%, or from 20% stabilizing agent, and may comprise (by weight) to 70%, or to 60%, or to 50%, or to 40%, or to 30%, or to 25% stabilizing agent. The amount of stabilizing agent present in the foam component depends on the amount and type of the active ingredient and on the amount and type of the matrix herein.

The foam component of the invention may also comprises a dissolution aid.

The dissolution aid may preferably comprise a sulfonated compound such as C₁-C₄ alk(en)yl sulfonates, C₁-C₄ aryl sulfonates, di iso butyl benzene sulphonate, toluene sulfonate, cumene sulfonate, xylene sulfonate, salts thereof such as sodium salts thereof, derivatives thereof, or combinations thereof, preferably di iso butyl benzene sulphonate, sodium toluene sulfonate, sodium cumene sulfonate, sodium xylene sulfonate, and combinations thereof.

The dissolution aid may comprise a C₁-C₄ alcohol such as methanol, ethanol, propanol such as iso-propanol, and derivatives thereof, and combinations thereof, preferably ethanol and/or iso-propanol.

The dissolution aid may comprise a C₄-C₁₀ diol such as hexanediol and/or cyclohexanediol, preferably 1,6-hexanediol and/or 1,4-cyclohexanedimethanol.

The dissolution aid may comprise compounds which are capable of acting as wicking agents, such as cellulosic based compounds, especially modified cellulose.

The dissolution aid may comprise swelling agents such as clays. Preferred clays are smectite clays, especially dioctahedral or trioctrahedral smectite clays. Highly preferred clays are montmorillonite clay and hectorite clay, or other clays found in bentonite clay formations.

The dissolution aid preferably comprises an effervescence system. A preferred effervescence system comprises an acid source capable of reacting with an alkali source in the presence of water to produce a gas. The acid source may be any organic, mineral or inorganic acid, or a derivative thereof, or a mixture thereof. Preferably the acid source comprises an organic acid. Suitable acid sources include citric, malic, maleic, fumaric, aspartic, glutaric, tartaric succinic or adipic acid, monosodium phosphate, boric acid, or derivatives thereof. Citric acid, maleic or malic acid are especially preferred.

The molecular ratio of the acid source to the alkali source present is preferably from 50:1 to 1:50, more preferably from 20:1 to 1:20 more preferably from 10:1 to 1:10, more preferably from 5:1 to 1:3, more preferably from 3:1 to 1:2, more preferably from 2:1 to 1:2.

It is highly preferred that the foam component comprises a plasticizer. Preferred plasticizers are selected from glycerol, ethylene glycol, diethyleneglycol, propylene glycol, sorbitol and mixtures thereof.

Coloring agent to color the foam component such as iron oxides and iron hydroxydes, azo-dyes, natural dyes, are also preferred, preferably present at levels of 0.001% and 10% or even 0.01 to 5% or even 0.05 to 1% by weight of the component.

It may be preferred that the foam component contains an acidic material and/or an alkaline material and/or buffering agent. This may be the polymeric material and/or the active ingredient, or an additional ingredient. It has been found that in particular the presence of an acidic material improves the dissolution and/or dispersion of the foam component of the invention upon contact with water, and can also reduce or prevent interactions, leading to for example precipitation, of the polymeric material in the foam component with cationic species present in the aqueous medium.

It may also be preferred to include a preservative ingredient in the foam component to prevent microbial contamination or growth. Examples may include formaldehyde and formaldehyde releasing materials any other known preservative material.

Liquid

The liquid herein is preferably a solvent for the polymeric material and/or the active material. Preferably the liquid or solvent comprises at least water.

Also preferred are also organic solvents such as alkanes, alkenes, alcohols, aromatic solvents such as benzene, phenol.

Polymeric Material

Any polymeric material which can be formed into a air-stable, water-unstable foam, can be used in the foam shape and component and can be used to form the matrix or part thereof, of the foam shape and component. Preferred it that the polymeric material comprises a water-dispersible or more preferably a water-soluble polymer.

Preferred water-dispersible polymers herein have a dispensability of at least 50%, preferably at least 75% or even at least 95%, as measured by the method set out hereinafter using a glass-filter with a maximum pore size of 50 microns; more preferably the polymer herein is a water-soluble polymer which has a solubility of at least 50%, preferably at least 75% or even at least 95%, as measured by the method set out hereinafter using a glass-filter with a maximum pore size of 20 microns, namely:

Gravimetric method for determining water-solubility or water-dispersability of polymers:

50 grams±0.1 gram of polymer is added in a 400 ml beaker, whereof the weight has been determined, and 245 ml±1 ml of distilled water is added. This is stirred vigorously on magnetic stirrer set at 600 rpm, for 30 minutes. Then, the water-polymer mixture is filtered through a folded qualitative sintered-glass filter with the pore sizes as defined above (max. 20 or 50 microns). The water is dried off from the collected filtrate by any conventional method, and the weight of the remaining polymer is determined (which is the dissolved or dispersed fraction). Then, the % solubility or dispersability can be calculated.

Preferred are polymers selected from polyvinyl alcohols, polyvinyl pyrrolidone, polyalkylene oxides, cellulose ethers, polycarboxylic acids and salts, polyaminoacids or peptides, polyamides, polyacrylamide, or derivatives or copolymers thereof. More preferably the polymer is selected from polyvinyl alcohols or derivatives thereof, cellulose ethers derivatives, including hydroxypropyl methylcellulose, copolymers of maleic/acrylic acids or mixtures thereof. Most preferred is that the polymeric material comprises or consists of polyvinyl alcohol and/or derivative thereof.

Copolymers, block polymers and graft polymers of the above can also be used.

Mixtures of polymers can also be used. This may in particular be beneficial to control the mechanical and/or dissolution properties of the foam component, depending on the application thereof and the required needs.

The polymer can have any mean average molecular weight, preferably from about 1000 daltons to 1,000,000 daltons, or even form 4000 daltons to 250,000 daltons or even from 10,000 daltons to 200,000 daltons or even form 20,000 daltons to 75,000 daltons. Gel permeation chromatography is one suitable method for measuring molecular weight.

Preferred can be that the polymeric material used in the foam shapes/component herein has a secondary function in water, for example when the foam component comprises a unit dose of a cleaning products, it is useful that polymer is a builder polymer, soil release polymer, dye transfer inhibiting polymer, process aid, suds suppressor, dispersant, flocculant etc.

Active Ingredient

The active ingredient can be any material which is to be delivered to an aqueous environment and which is active (performs) in an aqueous environment. For example, when used in cleaning compositions the foam component can contain any active cleaning ingredients. Highly preferred ingredients are hazardous materials, agrochemicals, drugs or medicines, cleaning actives.

The active ingredient may be a mixture of materials, for example, a complete product formulation may be incorporated in the foam component. For example, the active material may be a complete cleaning product formulation, i.e. comprising preferably at least builder and surfactant, preferably also enzymes and perfume, preferably also chelating agent, bleach, brighteners, suds suppressers.

In particular, it is beneficial to incorporate in the foam component active ingredients which are heat-sensitive (unstable, reactive under increased or reduced heat), volatile, moisture sensitive (react upon contact with moisture), or solid ingredients which have a limited impact robustness and tend to form dust during handling. In particular preferred in foam components are active ingredients such as enzymes, perfumes, bleaches, bleach activators, fabric softeners, fabric and hair conditioners, dyes, colorants, surfactants, such as liquid nonionic surfactant, conditioners, antibacterial agents, effervescence sources, brighteners, photo-bleaches and mixtures thereof.

Preferred are anionic surfactants, which include soaps salts (including, for example, sodium, potassium, ammonium, and substituted ammonium salts such as mono-, di- and triethanolamine salts) of the anionic sulfate, sulfonate, carboxylate and sarcosinate surfactant, preferably linear or branched alkyl benzene sulfonate, alkyl sulphates and alkyl ethoxylsulfates, isethionates, N-acyl taurates, fatty acid amides of methyl tauride, alkyl succinates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), N-acyl sarcosinates.

Also preferred are nonionic surfactants such as nonionic surfactant, preferably selected from can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts.

Cationic surfactants and softening agents may also be included as active ingredient in the foam component herein, for example to quaternary ammonium surfactants and softening agents, and choline ester surfactants.

Perfumes or perfume compositions are highly preferred as (one of the) active ingredients in the foam component.

Another active ingredient is hydrogen peroxide and/or perhydrate bleach, such as salts of perborates, percarbonates, particularly the sodium salts. Also preferred active ingredients are organic peroxyacid bleach precursor or activator compound, preferred are alkyl percarboxylic precursor compounds of the imide type include the N-,N,N¹N¹ tetra acetylated alkylene diamines wherein the alkylene group contains from 1 to 6 carbon atoms, particularly those compounds in which the alkylene group contains 1, 2 and 6 carbon atoms such as tetraacetyl ethylene diamine (TAED), sodium 3,5,5-tri-methyl hexanoyloxybenzene sulfonate (iso-NOBS), sodium nonanoyloxybenzene sulfonate (NOBS), sodium acetoxybenzene sulfonate (ABS) and pentaacetyl glucose, but also amide substituted alkyl peroxyacid precursor compounds.

Highly preferred active ingredients for use in the foam component herein are one or more enzymes. Preferred enzymes include the commercially available lipases, cutinases, amylases, neutral and alkaline proteases, cellulases, endolases, esterases, pectinases, lactases and peroxidases conventionally incorporated into detergent compositions. Suitable enzymes are discussed in U.S. Pat. Nos. 3,519,570 and 3,533,139. Preferred commercially available protease enzymes include those sold under the trade names Alcalase, Savinase, Primase, Durazym, and Esperase by Novo Industries A/S (Denmark), those sold under the trade name Manatees, Maximal and Maxine by Gist-Brocades, those sold by Tenneco International, and those sold under the TRADENAME Opticlean and Optimase by Solvay Enzymes. Preferred amylases include, for example, α-amylases obtained from a special strain of B licheniformis, described in more detail in GB-1,269,839 (Novo). Preferred commercially available amylases include for example, those sold under the trade name Rapidase by Gist-Brocades, and those sold under the trade name Termamyl, Duramyl and BAN by Novo Industries A/S. Highly preferred amylase enzymes maybe those described in PCT/US 9703635, and in WO95/26397 and WO96/23873. The lipase may be fungal or bacterial in origin being obtained, for example, from a lipase producing strain of Humicola sp., Thermomyces sp. or Pseudomonas sp. including Pseudomonas pseudoalcaligenes or Pseudomas fluorescens. Lipase from chemically or genetically modified mutants of these strains are also useful herein. A preferred lipase is derived from Pseudomonas pseudoalcaligenes, which is described in Granted European Patent, EP-B-0218272. Another preferred lipase herein is obtained by cloning the gene from Humicola lanuginosa and expressing the gene in Aspergillus oryza, as host, as described in European Patent Application, EP-A-0258 068, which is commercially available from Novo Industria A/S, Bagsvaerd, Denmark, under the trade name Lipolase. This lipase is also described in U.S. Pat. No. 4,810,414, Huge-Jensen et al, issued Mar. 7, 1989.

In personal-care foam components, it may be highly preferred that the active material includes cationic organic compounds, such as cationic surfactants, ingredient which can reduce dermatitis or compounds which can help the healing of the skin, metal-containing compounds, in particular zinc-containing compounds, vitamins and cortisone's, and also compounds to soften the skin such as Vaseline®, lanolin, and other actives typically employed by pharmaceutical and cosmetic manufactures.

In personal cleaning compositions it is preferred that the active material at least comprises a surfactant, preferably at least an anionic surfactant, preferably at least a soap, and a perfume or perfume compositions.

Complete product compositions may also be included as preferred active ingredients, such as commercially available cleaning products, pharmaceutical products, personal-care products, cosmetic products and fabric-care products.

Form of Foam Component

The foam component can be made into any form, by any conventional method. Preferred may be that the foam component is in the form of an object having layers of foam shapes, for example a geometric shape such as sphere, ball, cube, or letters or animal shape for a children's product, what ever is desirable for the user.

The foam component form of layers of sheet, which can have any dimension and can be subsequently reduced in size as required. It may be preferred that the sheet has a mean thickness of from of from 0.01 microns to 10 centimeters, more preferably from 0.05 microns to 1 centimeters, or even more preferably from 0.1 microns to 0.5 centimeters. Preferred is that the sheets are from 0.1 to 3 mm or even 0.3 to 2 mm and that the foam component comprises at least 3 or even at least 4 or even at least 5 or even at least 6 of such layers.

The foam component may also be an absorbent article or comprised in an absorbent article such as a feminine protection article, or diaper, or an article to cover the skin to release the actives in the to the skin whereto the absorbing articles is applied, when in contact with water, such as body fluids, for example diapers, wipes, catamenials, plaster, bandages.

### PROCESSING EXAMPLE

In a Kenwood Chef food mixer, 80 gr polyvinyl alcohol (Sigma-Aldrich, P8136), 40 gr glycerin (Sigma-Aldrich, 13487-2), 25 gr of citric acid (Sigma-Aldrich C8,315-5) and 250 gr of Orignial Source Lemon shower gel (commercially available) were mixed at maximum speed for 5 minutes, resulting in a dense, stiff mixture with foam structure.

This was spread on metal trays forming thin layers approximately 1 mm thick, and this was the placed in forced draught oven at 55° C. for 10 minutes. The dried foam shapes (sheets) were removed from the oven and peeled off the metal trays.

Using a spray-paint canister, a fine mist of water was sprayed onto one side of one of the foam sheets, and another sheet pressed down onto it. With a firm even pressure over the whole sheet area for about 10 seconds, the two sheets were bonded. This process was repeated several times to build a laminated foam component of 8 sheets with a depth of approximately 10 mm and a density of approximately 0.25 g/cm3. The laminated foam component could be easily cut and shaped without separation of the layers and the foam component dissolves well in water.

This experiment was repeated with (replacing the 250 gr shower gel):

250 gr enzyme (protease, lipase, amylase, cellulase or mixtures thereof);

250 gr of a mixture of (weight %) 30% LAS(linear alkyl benzene sulphonate sodium salt), 20% perfume oil, 20% soap, 10% bleach, 20% cationic surfactant;

250 gr of a mixture of (weight %) 80% betaine surfactant, amphoteric surfactant, cationic surfactant, anionic surfactant and/or nonionic surfactant (70% active paste of one or more of these surfactants) and 20% perfume oil;

250 gr of a 70% active paste of cationic fabric softening agent or cationic hair conditioner;

250 gr of a mixture of (by weight) 40% sodium percarbonate 30% activator, 30% surfactant.

What is claimed is:

1. A process for making a foam component, which is stable upon contact with air and unstable upon contact with water, by:
a) obtaining a first wet foam shape and a second wet foam shape, each comprising a polymeric material, an active material and a liquid;
b) evaporating part or all of the liquid of the first and/or second foam shape to obtain dry or partially dry foam shape(s);
c) placing the first foam shape and the second foam shapes of step b) against one another and attaching the shapes to one another.

2. Process of claim 1 whereby the foam shapes are obtainable by a process involving the step of making a liquid mixture of a polymeric material, active material and a liquid and foaming this mixture.

3. Process according to claim 1 whereby the foam shapes are obtainable by a process involving:
a) obtaining a liquid mixture of a polymeric material and an active material and a liquid;
b) introducing in the mixture a gas or an gas-forming agent (which forms a gas at 25° C. and at atmospheric pressure); and
c) shaping the mixture of step b) to form a foam shape.

4. Process according to claim 3 whereby prior to step c) the mixture is pressurized with a pressure of at least 2 bar; and in the shaping step the pressure is released, hereby at least partially evaporating the liquid, to obtain the dry or partially dry foam shape.

5. A process according to claim 1, whereby the evaporation step involves heating the wet or partially dry foam shapes, up to a temperature of 70° C., and/or vacuum freeze-drying the wet or partially dry foam shapes.

6. A process according to claim 2 whereby the foam shape or shapes comprise a matrix of polymeric material comprising polyvinyl alcohol polymer and/or a derivative thereof.

7. A process according to claim 1 whereby the foam shape or shapes comprises a volatile and/ or heat-sensitive active material.

8. A process according to claim 1 whereby
the first and/or second foam shape are partially dry and attached to one another by further drying; and/or
the first and second foam shapes are dry and are attached to one another by partially re-wetted the first foam shape and/or second foam shape.

9. Process according to claim 1 whereby the foam components are attached to one another with a gluing agent.

10. Process according to claim 1 whereby the foam shapes are in the form of sheets and said sheets are placed on one another, to form a layered foam component.

11. A foam component obtainable by a process according to claim 1.

12. A foam component according to claim 10, in the form of an article having two or more layers formed from the foam shapes.

13. A foam component according to claim 10 whereby the active material comprises a cleaning product ingredient, fabric care ingredient, pharmaceutical ingredient, cosmetic ingredient, personal care ingredient, or mixture thereof.

14. A flexible foam component according to claim 10 which has an elastic modulus of less than 10 GN.m⁻²,

15. A foam component according to claim 10 which has a relative density of 0.05 to 0.9.

16. A foam component according to claim 11 comprising a plasticizer.

17. A foam component according to claim 16 wherein the plasticizer is glycerol, ethylene glycol, diethyleneglycol, propylene glycol, sorbitol, or a mixture thereof.
